(19) United States
(12) Patent Application Publication
(10) Pub. No.: US 2011/0202794 A1
(43) Pub. Date: Aug. 18, 2011

(54) METHOD OF RESTORING MASTER BOOT RECORD OF STORAGE MEDIUM, STORAGE MEDIUM DRIVING DEVICE, AND STORAGE MEDIUM

(75) Inventor: Ki-woong KIM, Gunpo-si (KR)

(73) Assignee: Samsung Electronics Co., Ltd, Suwon-si (KR)

(21) Appl. No.: 13/028,465

(22) Filed: Feb. 16, 2011

(30) Foreign Application Priority Data
Feb. 16, 2010 (KR) 10-2010-13858

(51) Int. Cl. G06F 11/07

(52) U.S. Cl. 714/15; 714/E11.023

(57) ABSTRACT

A storage medium driving device including a storage medium having a user area and a non-user area, and to record master boot record information that is backed up in the non-user area, and a controller to compare the backup master boot record information with master boot record information read from the user area, and to restore master boot record information recorded in the user area according to the comparison results.

### CROSS-REFERENCE TO RELATED APPLICATIONS

This application claims priority under 35 U.S.C. §119(a) from Korean Patent Application No. 10-2010-0013858, filed on Feb. 16, 2010, in the Korean Intellectual Property Office, the disclosure of which is incorporated herein in its entirety by reference.

### BACKGROUND

1. Field of the Invention

The present general inventive concept relates to a method of restoring damaged information of a storage medium, and, more particularly, to a method of restoring a master boot record (MBR) of a storage medium, a storage medium driving device to perform the same, and a storage medium thereof.

2. Description of the Related Art

Storage medium driving devices such as hard disk drives read data recorded in a storage medium or record data in the storage medium. A storage medium of such storage medium driving devices has MBR information stored therein for booting an operating system. The MBR information includes a program such as a boot loader and partition information of a storage medium. The partition information includes location information of partitions of the storage medium. Thus, a MBR may also be referred to as a partition sector or a master partition table.

A host detects location information of a boot record by referring to MBR information transmitted from a storage medium driving device, and transmits a read command including the detected location information to the storage medium driving device. Accordingly, the storage medium driving device reads from storage medium boot record information according to the location information included in the read command to transmit the boot record information to the host, and the host boots an operating system based on the received boot record information. The boot record may also be referred to as a partition boot record or a boot sector.

If a multi-booting boot record is recorded in a storage medium, the storage medium is partitioned into a plurality of partitions, and a boot record is recorded for each partition. In this case, if a user selects a desired operating system for booting based on the MBR information received from the storage medium driving device, a host transmits to a storage medium driving device a read command for reading a boot record of a partition in which the selected operating system is installed. The storage medium driving device reads the boot record from the storage medium by using the location information included in the read command and transmits the boot record to the host, and the host boots the selected operating system by using the received boot record information.

Thus, if the MBR transmitted from the storage medium driving device to the host is damaged, the host may not boot an operating system. Therefore, the damaged MBR should be restored.

### SUMMARY

The present general inventive concept provides a method of restoring a damaged master boot record (MBR) in a storage medium driving device before the MBR is transmitted from the storage medium driving device to a host, a storage medium driving device to perform the same, and a storage medium thereof.

Additional features and utilities of the present general inventive concept will be set forth in part in the description which follows and, in part, will be obvious from the description, or may be learned by practice of the present general inventive concept.

Exemplary embodiments of the present general inventive concept provide a storage medium driving device including a storage medium including a user area and a non-user area, and to record master boot record information that is backed up in the non-user area, and a controller to compare the backup master boot record information with master boot record information read from the user area, and to restore master boot record information recorded in the user area according to the comparison result.

The controller may compare the backup master boot record information with master boot record information read from the user area based on a value of a flag that is set when the backup master boot record information has been read from the non-user area.

When the controller reads the backup master boot record information from the non-user area, the controller may set as a first value to a flag that the backup master boot record information has been read, and when the comparison between the backup master boot record information with maser boot record information read from the user area is performed, the controller may convert the flag to a second value.

When the controller receives a read command from a host and the flag representing that the backup master boot record information has been read is the second value, the controller may not compare the backup master boot record information with master boot record information read from the user area.

When the backup master boot record information is determined by the controller to be inconsistent with the master boot record information read from the user area, the controller may copy the backup master boot record information to the user area when transmitting the backup master boot record information to the host to restore the master boot record information in the user area.

When the backup master boot record information is determined by the controller to be consistent with the master boot record information read from the user area, the controller may transmit the master boot record information read from the user area to the host.

Exemplary embodiments of the present general inventive concept a method of restoring a master boot record of a storage medium in a storage medium driving device, the method including comparing backup master boot record information read from a non-user area of a storage medium with master boot record information read from a user area of the storage medium, and when the backup master boot record information is inconsistent with the master boot record information read from the user area, restoring master boot record information recorded in the user area by using the backup master boot record information.

The comparing may be performed based on a value of a flag that is set when the backup master boot record information has been read from the non-user area.

The comparing may include setting a flag to a first value when the backup master boot record information has been read from the non-user area, and converting the flag to a second value, when the comparing of the backup master boot record information with the master boot record information is performed.

The comparing may further include that, when a read command is received from a host and when the flag is the second value, skipping the comparing of the backup master boot record information with the master boot record information.

The restoring may be performed such that when the backup master boot record information is inconsistent with the master boot record information read from the user area, the backup master boot record information is copied to the user area when being transmitted to the host to restore the master boot record information recorded in the user area.

The restoring of the master boot record information may further include transmitting the master boot record information read from the user area to the host when the backup master boot record information is consistent with the master boot record information read from the user area.

Exemplary embodiments of the present general inventive concept also provide a computer readable storage medium to record a program, that, when executed by a computer, provides a method of restoring a master boot record, the method including comparing backup master boot record information read from a non-user area of a storage medium with master boot record information read from a user area of the storage medium, and when the backup master boot record information is inconsistent with the master boot record information read from the user area, restoring master boot record information recorded in the user area by using backup master boot record information.

Exemplary embodiments of the present general inventive concept also provide a method of restoring a master boot record of a storage medium in a storage medium driving device, the method including determining whether backup master book record information matches master boot record information stored in a first area of the storage medium, and when the master book record information matches master boot record information of the first area, restoring the master boot record information of the first area with the backup master boot record information.

The method may also include that when the backup master book record information matches master boot record information stored in the first area of the storage medium, transmitting the master boot record in formation of the user area to a host that is communicatively coupled to the storage medium driving device.

The method may also include transmitting the backup master boot record information to a host that is communicatively coupled to the storage medium driving device.

Exemplary embodiments of the present general inventive concept may also provide a storage medium driving device including a storage medium including a first area having master boot record information, and a second area having backup master boot record information, and a controller to compare the backup master boot record information of the second area with the master boot record information of the first area, and to restore master boot record information recorded in the first area using the backup master boot record information when the master boot record information of the first area does not match the backup master boot record information of the second area.

### BRIEF DESCRIPTION OF THE DRAWINGS

The above and/or other utilities of the present general inventive concept will become apparent and more readily appreciated from the following description of the exemplary embodiments, taken in conjunction with the accompanying drawings, in which:

FIG. 1 illustrates a functional block diagram of a storage medium driving device according to exemplary embodiments of the present general inventive concept;

FIG. 2 is a schematic area structure diagram of a storage medium illustrated in FIG. 1, according to exemplary embodiments of the present general inventive concept;

FIG. 3 is a flowchart illustrating a method of restoring a master boot record (MBR) of a storage medium included in a storage medium driving device according to exemplary embodiments of the present general inventive concept; and

FIG. 4 is an example of a flowchart illustrating a comparison operation between MBR information in the method of restoring a MBR of a storage medium of FIG. 3 according to exemplary embodiments of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

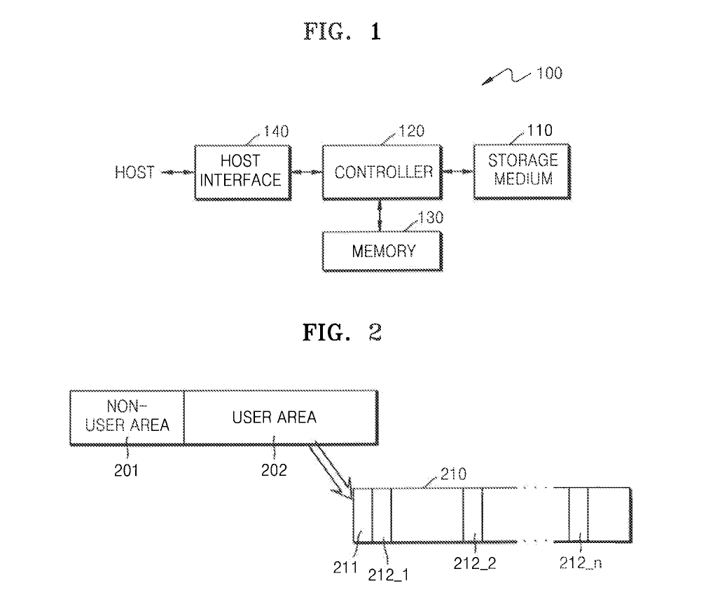

FIG. 1 is a functional block diagram of a storage medium driving device 100 according to exemplary embodiments of the present general inventive concept. The storage medium driving device 100 may be a device such as a hard disk drive or a solid state drive, but is not limited thereto. That is, the storage medium driving device 100 may be any suitable memory device that may have a master boot record to carry out the exemplary embodiments of the present general inventive concept as disclosed herein. The storage medium driving device 100 may be a storage medium driving device to drive a storage medium having a user area (e.g., a portion of the storage medium that is accessible by a user to read and write data) and a non-user area (e.g., a portion of the storage medium that is not accessible by a user to read and write data).

Referring to FIG. 1, the storage medium driving device 100 can include a storage medium 110, a controller 120, a memory 130, and a host interface 140.

FIG. 2 is a schematic area structure diagram of the storage medium 110 illustrated in FIG. 1, according to exemplary embodiments of the present general inventive concept. Referring to FIGS. 1 and 2, the storage medium 110 can include a non-user area 201 and a user area 202. The non-user area 201 can be a user non-accessible area (e.g., an area that a user may not read data from and/or write data to), and the user area 202 can be a user accessible area (e.g., an area that a user can read data from and/or write data to). Backup master boot record (MBR) information can be recorded in the non-user area 201.

The backup MBR information can be recorded in the non-user area 201 by a host (e.g., a server, a computer, a processor, and/or any other suitable device to carry out the exemplary embodiments of the present general inventive concept). That is, the controller 120 can copy MBR information recorded in the user area 202 to the non-user area 201 according to a command (or MBR backup command) received from the host, thereby recording the backup MBR information in the non-user area 201. When a hard disk is used as the storage medium 110, the non-user area 201 may be a maintenance cylinder (MC). Thus, information related to the storage medium driving device 100, which include defect list information and read/write optimization parameter information, as well as the backup MBR information, may be stored in the non-user area 201.

The MBR information can be recorded in a first sector (or a first track) of the user area 202, but is not limited thereto. The MBR information can include location information of each partition set on the storage medium 110 when the storage medium 110 is formatted. When a hard disk drive is the storage medium driving device 100, the MBR information can be recorded in LBA0 of the user area 202, but is not limited thereto. LBA0 is a first local block address on the hard disk drive.

Boot record information and user data may be recorded in the user area 202. The boot record information includes a program to boot an operating system for each partition. A boot record may generally be recorded in a first sector (or a first track) of the user area 202 for each partition, and the boot record can be read from the storage medium 110 by using MBR information.

If the storage medium 110 is multi-bootable (e.g., the storage medium 110 has a plurality of operating systems that can be booted), the user area 202 can be partitioned into a plurality of partitions 210 as illustrated in FIG. 2. In this regard, MBR information can be recorded in a first sector 211, and boot record information can be recorded in a first sector 212_1 through 212_{—}n of each partition. In this case, a host may boot one operating system selected from N number of operating systems. The operating system may be Microsoft® Windows® 7 (Win 7), Windows® Vista, Windows® XP (WinXP), or the like, but is not limited thereto.

The storage medium 110 may be referred to as a head disk assembly (HDA) of a hard disk drive.

The controller 120 can be a processor to control the storage medium driving device 100. In particular, the controller 120 can compare backup MBR information recorded in the non-user area 201 with MBR information recorded in the user area 202. According to the comparison result, the controller 120 can restore damaged MBR information recorded in the user area 202. In exemplary embodiments of the present general inventive concept, the controller can restore and/or replace the damaged MBR information recorded in the user area 202 with the backup MBR information recorded in the non-user are 201.

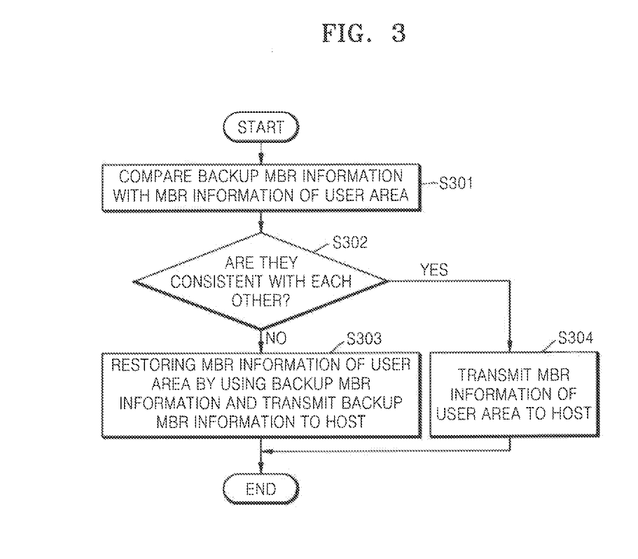

That is, the controller 120 may operate as described with reference to FIG. 3. FIG. 3 is an operational flowchart illustrating a method of restoring a master boot record (MBR) of the storage medium 110 included in the storage medium driving device 100, according to exemplary embodiments of the present general inventive concept.

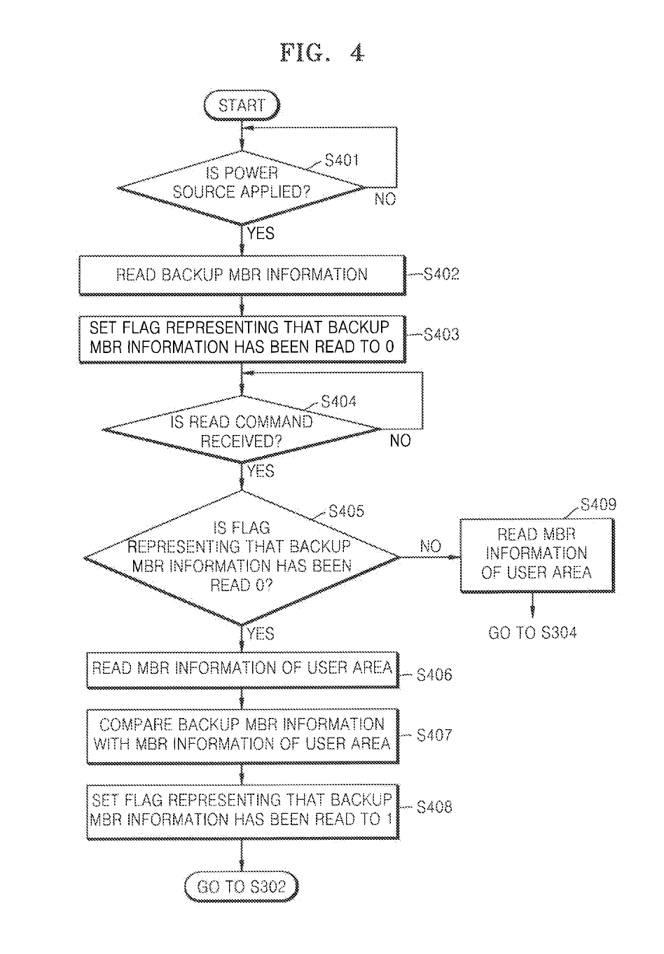

Referring to FIG. 3, the controller 120 can compare backup MBR information recorded in the non-user area 201 with MBR information recorded in the user area 202 at operation S301. The comparison between the backup MBR information recorded in the non-user area 201 and the MBR information recorded in the user area 202 may also be performed as illustrated in FIG. 4. FIG. 4 is an example of a detailed operational flowchart illustrating a comparison operation between MBR information in the method of restoring a MBR of the storage medium 110 of FIG. 3 according to exemplary embodiments of the present general inventive concept.

Referring to FIG. 4, as well as FIGS. 1 and 2, when it is determined that a power source is applied to the storage medium driving device 100 at operation S401, the controller 120 can read backup MBR information from the non-user area 201 at operation S402, and can set a flag representing that the backup MBR information has been read (hereinafter, referred to as “flag”) to 0 at operation S403. Flag=0 can indicate that the backup MBR information has been read to confirm whether the MBR information recorded in the user area 202 is damaged or not. The backup MBR information read from the non-user area 201 of the storage medium 110 and the flag information may be stored in the memory 130.

When a read command is received from the host (see FIG. 1) at operation S404, the controller 120 can check the flag stored in the memory 130 at operation S405. The received read command can be, for example, a command to boot an operating system or read MBR information. The received read command may be a read command including LBA0; however, LBA included in the received read command is not limited to LBA0. For example, if MBR information is written to another location (or another address) different from a location (or an address) in the storage medium 110 corresponding to LBA0, LBA include in the received read command may be LBA corresponding to the above-described different location. Operation S405 determines that if the flag is set to 0, the controller 120 can determine that the comparison between the backup MBR information and the MBR information has not been performed, and can read the MBR information from the user area 202 of the storage medium 110 at operation S406.

In operation S407, when the controller 120 compares the backup MBR information stored in the memory 130 with the MBR information read from the user area 202, the controller 120 can convert the flag stored in the memory 130 to 1 at operation S408, and the controller 120 may proceed to operation S302 of FIG. 3. If it id determined that flag is set to 1 at operation S405, the controller 120 can read the MBR information from the user area 202, and goes to operation S304 illustrated in FIG. 3. That is, the controller 120 can skip the comparing between the backup MBR information and the MBR information in the user area at operation S407. The flag information described throughout in connection with the exemplary embodiments of the present general inventive concept is not limited thereto. For example, if the flag is set to 1 in operation S403, the flag information may be set to 0 in operation S408. In this case, in operation S405, the controller 120 checks whether the flag information is 1.

Meanwhile, the operational flowchart illustrated in FIG. 4 may be modified such that the MBR information read from the storage medium 110 and MBR information read from the user area 202 are compared without considering the flag indicating that the backup MBR information has been read.

In other words, operations S403, S405, S408, and S409 may be removed from the operational flowchart of the method of FIG. 4. In this case, when a power source is applied to the storage medium driving device 100, the controller 120 reads the backup MBR information from the non-user area 201 of the storage medium 110 at operation S402. The read MBR information may be stored in the memory 130.

When a read command for reading MBR information or booting an operating system is received from a host (see FIG. 1) at operation 3404, the controller 120 reads MBR information from the user area 202 of the storage medium 110 at operation S406. The controller 120 compares the backup MBR information stored in the memory 130 with the MBR information read from the user area 202 at operation S407, and the controller 120 may proceed to operation S302 of FIG. 3.

In addition, operations S405 and S409 may be removed from the operational flowchart of the method illustrated in FIG. 4. In this case, when a power source is applied to the storage medium driving device 100, backup MBR information is read from the non-user area 201 at operation S402, and a flag representing that the backup MBR information has been read (hereinafter referred to as “flag”) is set to 0 at operation S403. Flag=0 indicates that the backup MBR information has been read in order to confirm whether the MBR information recorded in the user area 202 is damaged or not. The backup MBR information read from the non-user area 201 of the storage medium 110 and the flag information may be stored in the memory 130.

When a read command for reading MBR information or booting an operating system is received from a host (see FIG. 1) at operation S404, the controller 120 reads MBR information from the user area 202 of the storage medium 110 at operation S406. The controller 120 compares the backup MBR information stored in the memory 130 with the MBR information read from the user area 202 at operation 3407, and converts the flag stored in the memory 130 to 1 at operation S408. Then, the controller 120 may proceed to operation 3302 of FIG. 3.

The operational flowchart illustrated in FIG. 4 may also be modified in consideration of a case in which the read command received from the host is a read command other than the read command for reading MBR information or booting an operating system. In this case, operations S405 and S409 may be modified as follows. That is, operation S405 may be modified to an operation in which whether the received command is a command for reading MBR information or booting an operating system or not is checked: if the received command is a command for reading MBR information or booting an operating system, the controller 120 may proceed to operation S406; if the received command is not a command for reading MBR information or booting an operating system, the controller 120 may proceed to operation S409, wherein operation S409 may be modified to an operation in which data is read from a location (or an address) in the storage medium 110 corresponding to LBA included in the read command and the read data is transmitted to the host. Here, after performing operation S409, operation of the controller 120 may be ended.

Referring to FIGS. 1-3, in operation S302 illustrated in FIG. 3, the controller 120 can determine whether the backup MBR information is consistent with and/or matches the MBR information read from the user area 202. If operation S302 determines that the backup MBR information is inconsistent with and/or does not match the MBR information read from the user area 202, the controller 120 can determine that the MBR information recorded in the user area 202 is damaged. Accordingly, when the controller 120 transmits the backup MBR information stored in the memory 130 to the host (see FIG. 1) via the host interface 140, the controller 120 can copy the backup MBR information to the first sector of the user area 202, thereby restoring the MBR information recorded in the user area 202 at operation S303. The first sector of the user area 202 is a sector to which MBR information is written, and this sector is not limited to the first sector of the user area 202. Accordingly, the host can boot an operating system.

If it is determined that the backup MBR information is consistent with and/or matches the MBR information read from the user area 202 at operation S302, which indicates that the MBR information recorded in the user area 202 is not damaged, the controller 120 can transmit the MBR information read from the user area 202 to the host via the host interface 140 at operation S304. Accordingly, the host can boot an operating system.

The memory 130 may include firmware to control the storage medium driving device 100 and any type of control data that may be stored therein. In particular, programs and data (for example, flag information) to execute the methods illustrated FIGS. 3 and 4 may be stored in the memory 130. When a power source is applied to the storage medium driving device 100, information read from the non-user area 201 of the storage medium 110 may be loaded in the memory 130. The memory 130 may be a dynamic random access memory (DRAM), but is not limited thereto.

The host interface 140 can transmit and receive data between the host and the storage medium driving device 100. In particular, the host interface 140 can transmit any kinds of commands received from the host to the controller 120, and can transmit data read from the storage medium 110 by the controller 120 to the host.

A program for executing a method of restoring a MBR of a storage medium, according to exemplary embodiments of the present general inventive concept, may be embodied as computer readable codes on a computer readable recording medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although several embodiments of the present invention have been illustrated and described, it would be appreciated by those skilled in the art that changes may be made in these embodiments without departing from the principles and spirit of the general inventive concept, the scope of which is defined in the claims and their equivalents.

What is claimed is:

1. A storage medium driving device comprising:
a storage medium including a user area and a non-user area, and to record master boot record information that is backed up in the non-user area; and
a controller to compare the backup master boot record information with master boot record information read from the user area, and to restore the master boot record information recorded in the user area according to the comparison result.

2. The storage medium driving device of claim 1, wherein the controller compares the backup master boot record information with master boot record information read from the user area based on a value of a flag that is set when the backup master boot record information has been read from the non-user area.

3. The storage medium driving device of claim 1, wherein, when the controller reads the backup master boot record information from the non-user area, the controller sets as a first value to a flag that the backup master boot record information has been read, and when the comparison between the backup master boot record information with master boot record information read from the user area is performed, the controller converts the flag to a second value.

4. The storage medium driving device of claim 3, wherein, when the controller receives a read command from a host and the flag is the second value, the controller does not compare the backup master boot record information with master boot record information read from the user area.

5. The storage medium driving device of claim 4, wherein, when the backup master boot record information is determined by the controller to be inconsistent with the master boot record information read from the user area, the controller copies the backup master boot record information to the user area when transmitting the backup master boot record information to the host to restore the master boot record information in the user area.

6. The storage medium driving device of claim 5, wherein when the backup master boot record information is determined by the controller to be consistent with the master boot record information read from the user area, the controller transmits the master boot record information read from the user area to the host.

7. The storage medium driving device of claim 1, wherein, when the backup master boot record information is determined by the controller to be inconsistent with the master boot record information read from the user area, the controller copies the backup master boot record information to the user area while transmitting the backup master boot record information to the host to perform the restoring.

8. A method of restoring a master boot record of a storage medium in a storage medium driving device, the method comprising:
comparing backup master boot record information read from a non-user area of a storage medium with master boot record information read from a user area of the storage medium; and
when the backup master boot record information is inconsistent with the master boot record information read from the user area, restoring the master boot record information recorded in the user area by using the backup master boot record information.

9. The method of claim 8, wherein the comparing is performed based on a value of a flag that is set when the backup master boot record information has been read from the non-user area.

10. The method of claim 8, wherein the comparing comprises:
setting a flag to a first value when the backup master boot record information has been read from the non-user area; and
converting the flag to a second value when the comparing of the backup master boot record information with the master boot record information is performed.

11. The method of claim 10, wherein the comparing further comprises:
when a read command is received from a host and when the flag is the second value, skipping the comparing of the backup master boot record information with the master boot record information.

12. The method of claim 10, wherein the restoring is performed such that when the backup master boot record information is inconsistent with the master boot record information read from the user area, the backup master boot record information is copied to the user area when being transmitted to the host to restore the master boot record information recorded in the user area.

13. The method of claim 12, wherein the restoring of the master boot record information further comprises:
transmitting the master boot record information read from the user area to the host when the backup master boot record information is consistent with the master boot record information read from the user area.

14. The method of claim 8, wherein the restoring is performed such that when the backup master boot record information is inconsistent with the master boot record information read from the user area, the backup master boot record information is copied to the user area when being transmitted to the host to restore the master boot record information recorded in the user area.

15. A non-transitory computer readable storage medium that includes computer-readable codes that, when executed by a computer, performs the method of restoring a master boot record, the method comprising:
comparing backup master boot record information read from a non-user area of a storage medium with master boot record information read from a user area of the storage medium; and
when the backup master boot record information is inconsistent with the master boot record information read from the user area, restoring master boot record information recorded in the user area by using backup master boot record information.

16. A method of restoring a master boot record of a storage medium in a storage medium driving device, the method comprising:
determining whether backup master boot record information matches master boot record information stored in a first area of the storage medium; and
when the master boot record information matches master boot record information of the first area, restoring the master boot record information of the first area with the backup master boot record information.

17. The method of claim 16, further comprising:
when the backup master book record information matches master boot record information stored in the first area of the storage medium, transmitting the master boot record in formation of the user area to a host that is communicatively coupled to the storage medium driving device.

18. The method of claim 16, further comprising:
transmitting the backup master boot record information to a host that is communicatively coupled to the storage medium driving device.

19. A storage medium driving device comprising:
a storage medium including a first area having master boot record information, and a second area having backup master boot record information; and
a controller to compare the backup master boot record information of the second area with the master boot record information of the first area, and to restore master boot record information recorded in the first area using the backup master boot record information when the master boot record information of the first area does not match the backup master boot record information of the second area.
